(19) United States
(12) Patent Application Publication
(10) Pub. No.: US 2005/0086214 A1
(43) Pub. Date: Apr. 21, 2005

(54) Computer system and method for multilingual associative searching

(75) Inventors: Eric Seewald, Koln (DE); Gunter Buxbaum, Krefeld (DE); Ralf Pakull, Pulheim (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 10/967,401

(22) Filed: Oct. 18, 2004

(30) Foreign Application Priority Data
Oct. 21, 2003 (DE) 10348920.7

(51) Int. Cl. G06F 15/18; G06G 7/00; G06E 3/00; G06E 1/00; G06F 17/20; G06F 17/30; G06F 7/00

(52) U.S. Cl. 707/3; 706/16; 706/20; 704/8

(57) ABSTRACT

The invention relates to a method and digital storage medium and a computer system for multilingual associative searching. The method, medium or system provides for input of the search text in a first language, the search text is automatically translated into a second language, the search text translated into the second language is transferred to an associative search module, the associative search module including a neural network or a predefined algorithm which is designed to search on the basis of a search text in the second language.

### BACKGROUND OF THE INVENTION

The invention relates to a computer system, a method and a digital storage medium for multilingual associative searching.

Associative searching is a method which is known per se from the prior art. In contrast to normal database using prescribed query methods, associative searching does not involve the use of any prescribed query language to formulate a search query, but rather a text passage. The user can use the text passage to describe the contents of a search query in his own words or sentences.

The text message-type of search is based either on previously stipulated algorithms or on a neural network which has been trained beforehand. The neural network is trained using preclassified example documents. In this context, the text of an example document serves as an input parameter for the neural network, and the classification ascertained by the neural network is aligned with the prescribed classification in order to train the neurons.

An appropriate piece of software for associative searching is commercially available from SER Systems AG, SER brainware (www.ser.de). This program allows associative searching on the basis of example text passages. In this case, the associative search makes use of a neural network previously trained in a classification mode. The learning process used in the course of this is also referred to as “learning by example”.

A drawback of previously known associative search methods is that the search query can be formulated only in the same language of that in which the neural network has been trained.

Against this background, the invention provides an improved method for associative searching which allows a multilingual associative search. In addition, the invention provides an appropriate computer system and a digital storage medium.

Accordingly, the invention utilizes means of the features of the independent patent claims. Preferred embodiments of the invention are specified in the dependent patent claims.

### SUMMARY OF THE INVENTION

The invention provides a method for multilingual associative searching which allows the search text to be inputted in a first language which is different from a second language, in which the associative search module's neural network has been trained. To this end, the search text in the first language is translated into the second language by means of automatic translation and is then inputted into the associative search module. In this context, simple automatic translation methods based on word-for-word equivalence may be used, or else translation methods which take further-developed grammar and syntax into account may be used.

For this, the invention makes use of the surprising effect in that, although automatic translations, particularly automatic translations based on word-for-word equivalence, are relatively inaccurate and sometimes have barely comprehensible or grammatically incorrect translation results, such an automatically translated search text may nevertheless be used for an associative search without significantly impairing the quality of the associative search.

In accordance with one preferred embodiment of the invention, the language of the search text is recognized automatically. Such automatic recognition methods are known per se from the prior art and are implemented, by way of example, in Microsoft Word. The user is thus able to input his search text in any language which is supported by the system. The language of the search text is then recognized automatically and the translation module required for translating from the language of the search text into the second language is called.

In accordance with another preferred embodiment of the invention, the associative search is made in documents in different languages. To this end, a neural network is trained for each of the languages using example documents in the respective language.

Preferably, the results of the various associative searches are output in a single sorted list. To sort the list, this may involve the use of “ranking values” or “reliability values”, which indicate the degree to which the search text concurs with a hit.

In accordance with another preferred embodiment of the invention, text files are obtained from voice files through automatic voice recognition. These text files can then be searched using a method in accordance with the invention. A voice file is, by way of example, the sound file for a multimedia file stored on a DVD.

### BRIEF DESCRIPTION OF THE DRAWINGS

In the drawings, wherein like reference numerals delineate similar elements throughout the several views:

FIG. 1 shows a block diagram of a first embodiment of an inventive computer system,

FIG. 2 shows a flowchart for a first embodiment of a method in accordance with the invention,

FIG. 3 shows a block diagram of a second embodiment of a computer system in accordance with the invention having a plurality of language-specific neural networks,

FIG. 4 shows a flowchart for a second embodiment of a method in accordance with the invention for performing an associative search on the basis of a plurality of neural networks trained in various languages.

### DETAILED DESCRIPTION OF THE PRESENTLYPREFERRED EMBODIMENTS

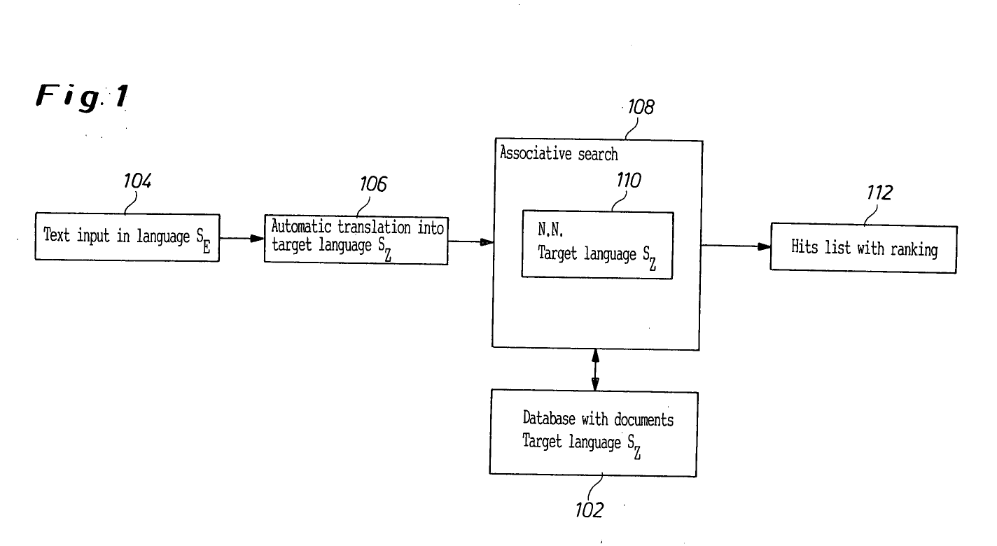

FIG. 1 shows a computer system 100 for performing an associative search in a database 102. The computer system 100 includes a user interface 104 for inputting a search text in an input language S_{E}. The computer system 100 also includes a translation module 106 for automatically translating from the input language S_{E} into a target language S_{Z}.

Generally, the translation module 106 may be any translation program. Preferably, a translation method based on word-for-word equivalence is used. Such translation methods are used in commercially available voice computers and are known per se from the prior art.

The computer system 100 also includes an associative search module 108 which comprises a neural network 110. The neural network 110 has been trained in a classification mode using documents in the target language S_{Z} which have been categorized by a user.

When a search text in the target language S_{Z} is inputted into the associative search module 108, the neural network 110 is used to ascertain documents in the database 102 which belong to the category matched by the search text. In addition, each of the “hits” has a “ranking value” output which indicates the degree of concurrence between the search text and the hit. The corresponding hits list is preferably sorted according to the ranking values and is output as hits list 112 via the user interface 104.

During operation of the computer system 100, a user uses the user interface 104 to input an input text in the input language S_{E}. The search text may be a search query in which the user uses a few words, sentences or an example text passage to describe the contents of the documents which are to be sought.

Input of the search text in the language S_{E} starts the translation module 106, which translates the search text into the target language S_{Z} automatically. The translated search text is then input into the associative search module 108.

Using the neural network 110, documents in the database 102 which are similar to the search text are then identified and assessed with a ranking value in an extraction mode. The corresponding results are output as hits list 112, each element of the hits list being able to be a hyperlink to the relevant document in the database 102, for example.

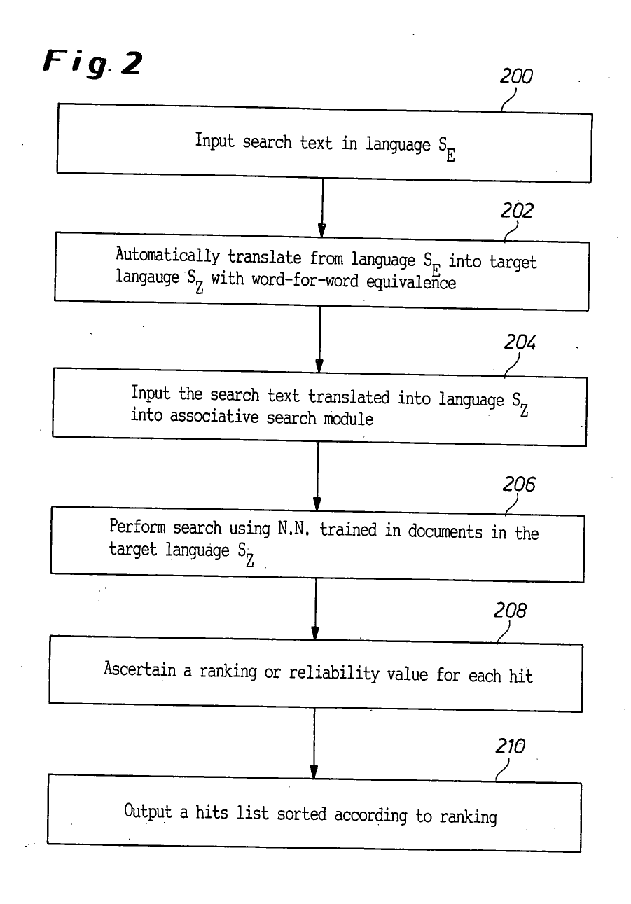

FIG. 2 shows a corresponding flowchart for implementing the method according to the invention. In step 200, a user inputs a search text in an input language S_{E}. The search text is then automatically translated from the input language S_{E} into a target language S_{Z} in step 202. Preferably, this automatic translation is performed using a relatively simple translation method which is based on word-for-word equivalence.

In step 204, the search text translated into the target language S_{Z} is input into an associative search module which has a neural network trained using documents in the target language S_{Z}. In step 206, the associative search is performed using the neural network. Besides the actual hits, the neural network also ascertains a ranking or reliability value for each of the hits (step 208). In step 210, the hits list sorted according to ranking is output.

A particular advantage when using a translation method based on word-for-word equivalence is that, firstly, the quality of the translation is sufficient for the purposes of associative searching and that, secondly, the time required for the translation is minimal. This is essential for user-friendly execution of database queries, since, particularly for reasons of software ergonomics, the latency between input of the search text and output of the hits list should be as short as possible.

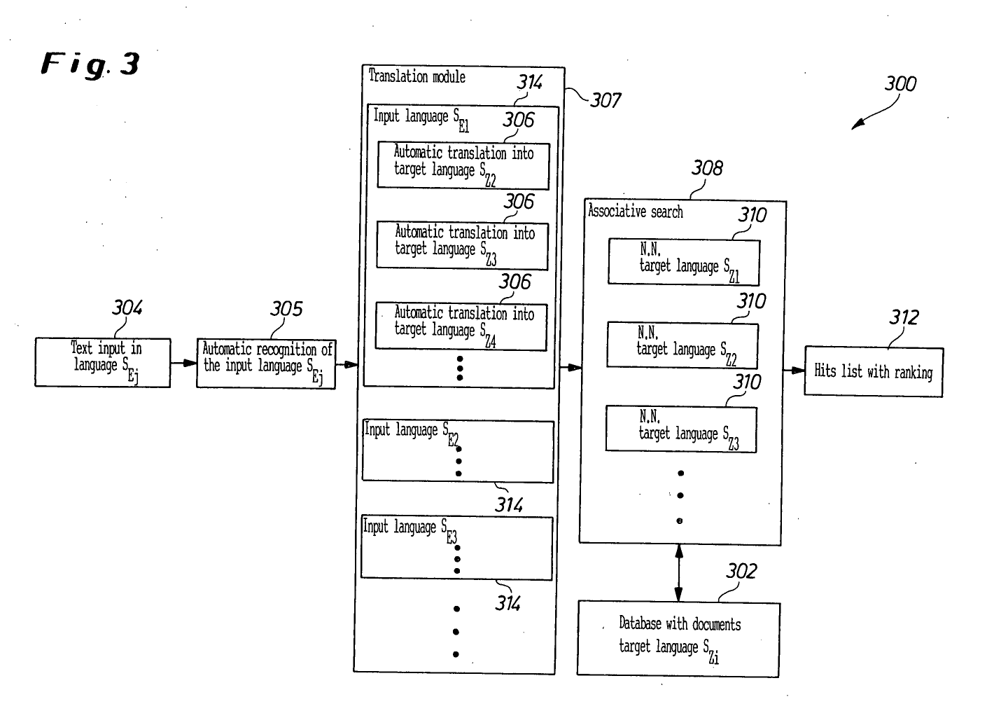

FIG. 3 shows a block diagram of a computer system 300. Elements in FIG. 3 which correspond to elements in FIG. 1 have been identified using reference numerals augmented by 200.

Unlike in the embodiment in FIG. 1, the user interface 304 allows a search text to be input in any language S_{Ej} which is supported by the computer system 300, where 0<j≦m. By way of example, the computer system 300 supports search queries in German, English, French, Japanese and Russian, i.e. m=5.

The user interface 304 is linked to a voice recognition module 305. The voice recognition module 305 automatically recognizes the input language S_{Ej} in which the user has input the input text using the user interface 304. The voice recognition module 305 is linked to a translation module 306.

The translation program 307 has a corresponding translation component 314 for each of the m different input languages S_{Ej} supported by the computer system 300. Each of the translation components 314 has a number of n translation modules 306 for automatically translating the input language S_{Ej} into one of the target languages S_{Zi} supported by the computer system 300, where 0<i≦n.

Subsequently, without limiting general nature, it is assumed that the number m of input languages supported by the computer system 300 is equal to the number n of target languages supported, and that also the input languages are identical to the target languages. In this case, each of the translation components 314 contains a number of m−1 translation modules 306 for translation from the respective input language into the other target languages.

By way of example, the translation component 314 for the input language German S_{E1} thus has translation modules 306 for automatic translation into the target languages English, French, Japanese and Russian. The situation is similar for the other translation components 314, which are each associated with another of the input languages.

The translation program 307 is linked to an associative search module 308. For each of the target languages, the associative search module 308 has a neural network 310 which has been trained using categorized documents in the respective target language. In the exemplary case under consideration, the associative search module 308 thus has a number of m different neural networks 310, with each of the neural networks 310 being associated with one of the languages supported by the computer system 300. Accordingly, the database 302 contains documents in these various languages which can be searched by means of an associative search. Alternatively, the documents may be stored distributed over a plurality of databases.

During operation of the computer system 300, the user uses the user interface 304 to input an input text in one of the input languages S_{Ej} which is supported by the computer system 300. The input language is then automatically recognized by the voice recognition module 305. Next, the translation component 314 associated with the input language is started, so that the search text is translated into the various target languages S_{Zi} which differ from the input language, where i≠j, using the translation modules 306 in the translation component 314 in question.

The various translations of the search text are then made the basis of the corresponding associative searches by the neural networks 310. In addition, the search text in the input language is also used for the associative search using one of the neural networks 310, since the input language is also simultaneously one of the target languages in the exemplary case under consideration here, of course. The results of the individual associative searches are then output in a sorted hits list 312 via the user interface 304.

Thus, when a user inputs, by way of example, a search text in German S_{E1} using the user interface 304, German is automatically recognized as the input language S_{E1} by the voice recognition module 305. The voice recognition module 305 then starts that translation component 314 in the translation module 307 which is associated with the input language German S_{E1}. Next, the search text is translated by the various translation modules 306 into the target languages English, French, Japanese and Russian.

In addition, the original search text is input into the neural network 310 associated with the German language for the purpose of performing an associative search. Accordingly, the search texts which have been translated into English, French, Japanese and Russian are input into those neural networks 310 in the associative search module 308 which are associated with the respective languages. The corresponding hits which are found in the respective language are preferably output in a common hits list 312 which has been sorted according to the ranking values.

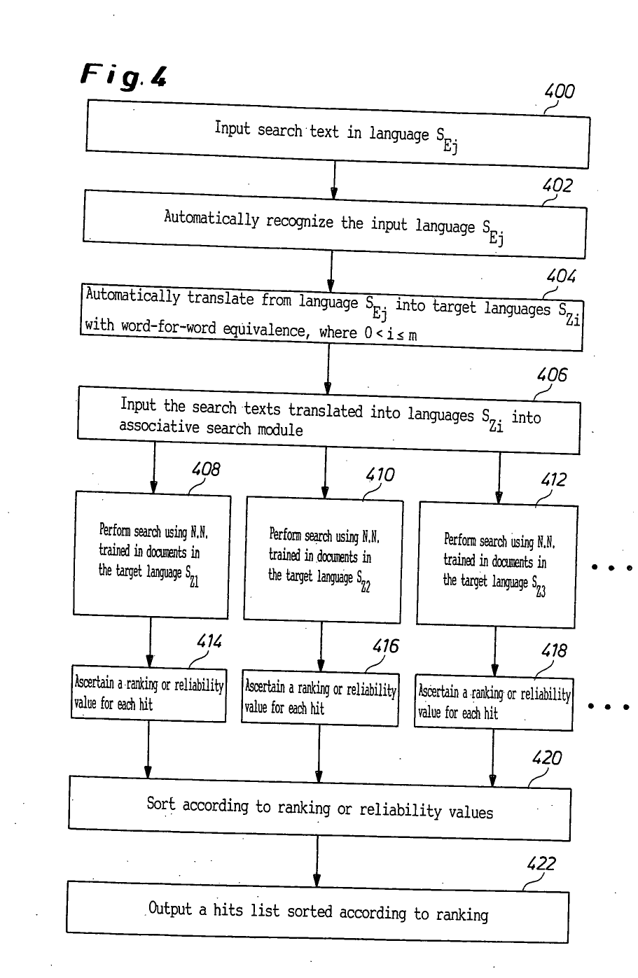

FIG. 4 shows a corresponding flowchart. In step 400, a search text is input in one of the languages S_{Ej} which is supported by the system. In step 402, the input language is automatically recognized, and the translation into the target languages which are different from the input language is then started in step 404. Preferably, this involves the use of a translation method based on word-for-word equivalence.

The search texts translated into the various target languages and also the search text in the input language—if the input language is one of the target languages—are input into the associative search module in step 406.

Next, respective associative searches for documents in the various target languages are performed in steps 408, 410, 412, which run in parallel. By way of example, step 408 involves a search for documents in the target language S_{Z1} being performed using the input text which has been translated into the target language S_{Z1}. Accordingly, step 410 involves a search for documents in the target language S_{Z2} being performed using the search text which has been translated into the target language S_{Z2} etc.

The corresponding steps 414, 416, 418, . . . involve a respective ranking value being calculated for each of the hits ascertained. In step 420, the hits are sorted according to ranking values, and are output in a single hits list in step 422

1. A method for multilingual associative searching, comprising the following steps:
inputting a search text in a first language,
automatically translating the search text into a second language,
transferring the search text translated into the second language to an associative search module, the associative search module comprising a neural network or a predefined algorithm which is designed to search on the-basis of a search text in the second language.

2. The method according to claim 1, comprising further steps:
providing means for automatically recognition of the first language,
selecting a program module for automatic translation from the first to the second language from a set of program modules for automatic translation between various languages.

3. The method according to claim 1, further providing means for the neural network ascertains a ranking value for each search result.

4. The method according to claim 1further comprising the step of automatically translating the first language into various second languages, and using a neural network trained to search in the respective language for each of the various second languages.

5. The method according to claim 4, wherein the search results from the neural networks are being outputted in a list sorted according to ranking values.

6. The method according to claim 1 the neural network has been trained using text files.

7. The method according to claim 6, wherein the text files have been obtained from voice files through automatic voice recognition.

8. The method according to claim 1, wherein the automatic translation is performed on the basis of word-for-word equivalence.

9. A digital storage medium for a multilingual associative search including program means, comprising:
means for inputting a search text in a first language, a translation module for automatic translation of the search text into a second language,
an associative search module containing a neural network trained to search on the basis of a search text in the second language, the associative search module having input means

10. The digital storage medium according to claim 9, further comprising a plurality of program modules for automatic translation between various languages, the program means being designed to recognize the first language automatically and to select at least one of the plurality of program modules for translation into the second language.

11. The digital storage medium according to claim 9 wherein the program means are designed to translate the search text into a plurality of different languages automatically, and a neural network trained in the respective language is used for the associative search.

12. The digital storage medium according to claim 11, wherein the program means are designed to sort the search results from the various neural networks.

13. The digital storage medium according to claim 9 wherein the program means are designed to perform the automatic translation on the basis of word-for-word equivalence.

14. A computer system for multilingual associative searching, comprising:
input means for inputting a search text in a first language,
means for automatically translating the search text into a second language,
an associative search module including a neural network, the neural network being trained to perform an associative search on the basis of a search text in the second language.

15. The computer system according to claim 14, further comprising means for automatically recognizing the first language and having means for selecting a program module from a set of program modules for automatic translation from the first into the second language.

16. The computer system according to claim 14 or 15, including a plurality of neural networks which have each been trained for an associative search on the basis of search texts in various languages.

17. The computer system according to claim 14, the means for automatic translation are designed to perform the automatic translation on the basis of word-for-word equivalence.
